(19) United States
(12) Patent Application Publication
(10) Pub. No.: US 2003/0202431 A1
(43) Pub. Date: Oct. 30, 2003

(54) Method for managing summary information of play lists

(76) Inventors: Mi Hyun Kim, Seoul (KR); Sung Ryun Cho, Seoul (KR); Byung Jin Kim, Bundang-gu (KR); Kang Soo Seo, Dongan-gu (KR); Sung Wan Park, Suwon-si (KR)

Correspondence Address: BIRCH STEWART KOLASCH & BIRCH, PO BOX 747, FALLS CHURCH, VA, 22040-0747, US

(21) Appl. No.: 10/421,727

(22) Filed: Apr. 24, 2003

(30) Foreign Application Priority Data
Apr. 24, 2002 (KR) 02-22473

(51) Int. Cl. G11B 7/085

(52) U.S. Cl. 369/30.09

(57) ABSTRACT

The present invention relates to a method of managing summary information of play lists. In the present method, summary information is written in a specific file other than a play list file wherein the summary information is summarized from information written in play list files created under file structure of a recording medium. Afterwards, the summary information written in the specific file is read, and at least one thumbnail representing a play list is displayed onto a menu screen for user selections with reference to the read summary information. Through the concentrated summary information, play list related information such as thumbnails can be displayed fast.

### BACKGROUND OF THE INVENTION

1. Field of the Invention

The present invention relates to a method for managing summary information of play lists that are management information for playback control of data streams recorded on an optical disk such as a rewritable high-density storage medium.

2. Description of the Related Art

The standardization of a high-capacity rewritable optical disk, so called ‘Blu-ray Disk Rewritable’ (abbreviated ‘BD-RW’), is in rapid progress so that various products related with a BD-RW will be developed and commercialized in the near future.

FIG. 1 is a simplified block diagram of an optical disk device, which may be a VDR (Video Disk Recorder), capable of recording and reproducing signals to/from a recording medium such as a BD-RW.

The disk device of FIG. 1 comprises an optical pickup 2 for reading signals recorded on a recording medium 1 such as a BD-RW and for writing data stream processed from input signals; a VDR system 3 for restoring digital data by processing the read signals from the optical pickup 2 and for converting the input signals to data stream whose format is suitable for recording; and an encoder 4 for encoding analog input to deliver to the VDR system 3.

The disk device configured as above searches the placed BD-RW 1 for play lists written thereon, and displays them as user's selection menu on a connected television set. Then, a user chooses a certain play list associated with a video clip he or she wants to be played.

After user's choice, the VDR system 3 of the disk device conducts a playback operation of a video clip associated with the chosen play list.

The above briefly-mentioned play list displaying operation is described below in more detail.

Shown in FIG. 3 is the fixed file structure of a BD-RW. The root directory contains at least one DVR directory which contains mandatory files such as ‘info.dvr’, ‘menu.tidx’, and ‘mark.tidx’, a PLAYLIST subdirectory in which play list files (real play list (*.rpls) and virtual play list (*.vpls)) are written, a CLIPINF subdirectory in which clip information files (*.clpi) are written, and a STREAM subdirectory in which data stream files (*.m2ts) corresponding to the clip information files are written.

The play control information on the data stream files stored in the STREAM subdirectory, for example, ‘01001.m2ts’ and ‘02000.m2ts’, can be stored in ‘01001.clpi’ and ‘02000.clpi’ contained in the CLIPINF subdirectory, respectively. The play list information for determining continued playback or playback sequence of the files ‘01001.m2ts’, ‘02000.m2ts’ and so on can be stored in the file ‘01001.rpls’ contained in the PLAYLIST subdirectory.

Shown in FIG. 4, table information of play lists ‘TableOfPlayLists’, which is used to search for play list files (*.rpls,*.vpls), is included in the file ‘info.dvr’. The table information includes the fields of the number of play lists ‘number_of_PlayLists’, and play list filenames ‘PlayList_file_name’ to identify individual play list files.

The VDR system 3 of the optical disk device of FIG. 1 sequentially examines play list files (*.rpls, *.vpls) under the subdirectory PLAYLIST with reference to the play list filenames written in the table information ‘TableOfPlayLists’. The sequential examining operations are conducted as many times as the field ‘number_of_PlayLists’ specifies. Through examination of play list files, the VDR system 3 reads necessary information to access individual thumbnail pictures in the file ‘menu.tidx’ and then displays some or all of them onto a menu screen as illustrated in FIG. 2.

However, the number of play lists is maximally allowed to 200 by the provisional standard for a BD-RW. Therefore, if many play lists have been created, displaying time of all summary information such as thumbnail pictures takes relatively much time because of sequential play list checking and summary information reading thereafter. Moreover, repetition of summary information reading and presentation has such a drawback that summary information of all play lists is displayed intermittently.

### SUMMARY OF THE INVENTION

It is an object of the present invention to provide a method for managing in concentrative way summary information of play lists written on a recording medium such as a BD-RW in order to display the summary information faster.

A method of managing information of play lists in accordance with the present invention is characterized in that it writes summary information in a specific file other than a play list file wherein the summary information is summarized from information written in respective play list files created under file structure of a recording medium.

Another method of managing information of play lists in accordance with the present invention is characterized in that it reads play list summarized information written in a specific file other than a play list file created under file structure of a recording medium, and displays at least one thumbnail representing a play list onto a menu screen for user selection with reference to the read play list summarized information.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 is a simplified block diagram of an optical disk device such as a video disk recorder;

FIG. 2 illustrates a menu screen where play lists on a BD-RW are displayed;

FIG. 3 illustrates a file structure adopted for a BD-RW;

FIG. 4 shows syntax of a mandatory file ‘info.dvr’ created on a BD-RW;

FIG. 5 shows new syntax of a mandatory file ‘info.dvr’ of a BD-RW created by a method of managing play list summarized information in accordance with the present invention;

FIG. 6 shows play list summarized information in detail; and

FIG. 7 shows another syntax of a mandatory file ‘info.dvr’ in which play list summarized information is written in accordance with the present invention.

### DETAILED DESCRIPTION OF THE PREFFERRED EMBODIMENT

In order that the invention may be fully understood, preferred embodiments thereof will now be described with reference to the accompanying drawings.

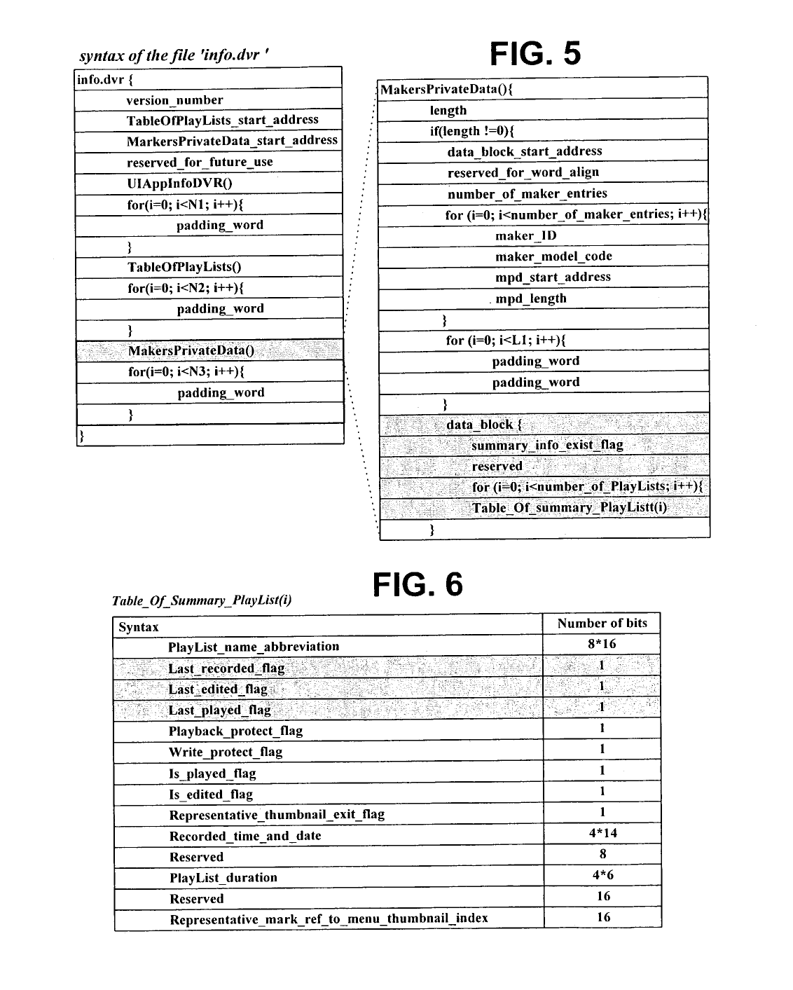

A BD-RW 1 has a file ‘info.dvr’ including a field ‘MakersPrivateData’ reserved for various information on makers producing a BD-RW, as shown in FIG. 5. In the embodiment of he present invention, the data block subfield ‘data_block’ is allocated in the field ‘MakersPrivateData’ to include summary information of play lists in its member named ‘Table_Of_summary_PlayList(i)’.

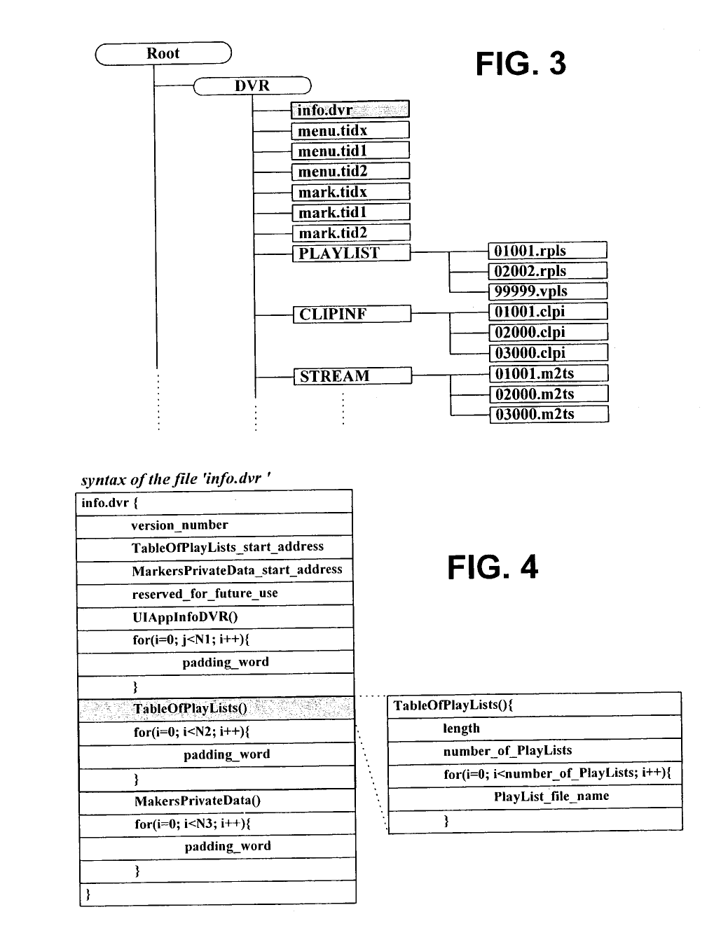

The information of the play lists written individually in the respective play list files (*.rpls,*.vpls) under the subdirectory ‘PLAYLIST’, which is mentioned with reference to FIG. 3, is summarized and then concentrated in the member ‘Table_Of_summary_PlayList(i)’.

FIG. 6 shows the structure of each play list summarized information member ‘Table_Of_summary_PlayList(i)’ in detail. The member includes an abbreviated name of play list ‘PlayLIst_name_abbreviation’, a lately-recorded flag ‘Last_recorded_flag’ that is set if recorded last, a lately-edited flag ‘Last_edited_flag’ that is set if edited last, a lately-played flag ‘Last_Played_flag’ that is set if played last, a play-protected flag ‘Playback_protect_flag’ indicative of whether or not playback is prohibited, a write-protected flag ‘Write_protect_flag’ indicative of whether or not writing is allowed, a play flag ‘is_played_flag’ that is set if played, an edit flag ‘is_edited_flag’ that is set if edited, a thumbnail flag ‘Representative_thumbnail_exit_flag’ that is set if there is a related representative thumbnail, recording time/date ‘Recorded_time_and_date’, duration of a play list ‘PlayList_duration’, and a thumbnail index ‘Representative_mark_ref_to_menu_thumbnail_index’ to index a thumbnail picture representing a play list.

The three flags, the lately-recorded flag, the lately-edited flag, and the lately-played flag are added to provide a user with more information about a play list. The above-mentioned flags can be also inserted in individual play lists under the subdirectory ‘PLAYLIST’.

The field MPD (MakerPrivateData) includes a data block start address ‘data_block_start_address’ and a block length ‘length’ as shown in FIG. 5. The data block start address points to the area of the data block subfield and the block length indicates the size of MPD field.

The above-explained field/subfield expansion for addition of play list summarized information is not against the file structure of a BD-RW and syntax of the file ‘info.dvr’ that have been explained with reference to FIGS. 3 and 4.

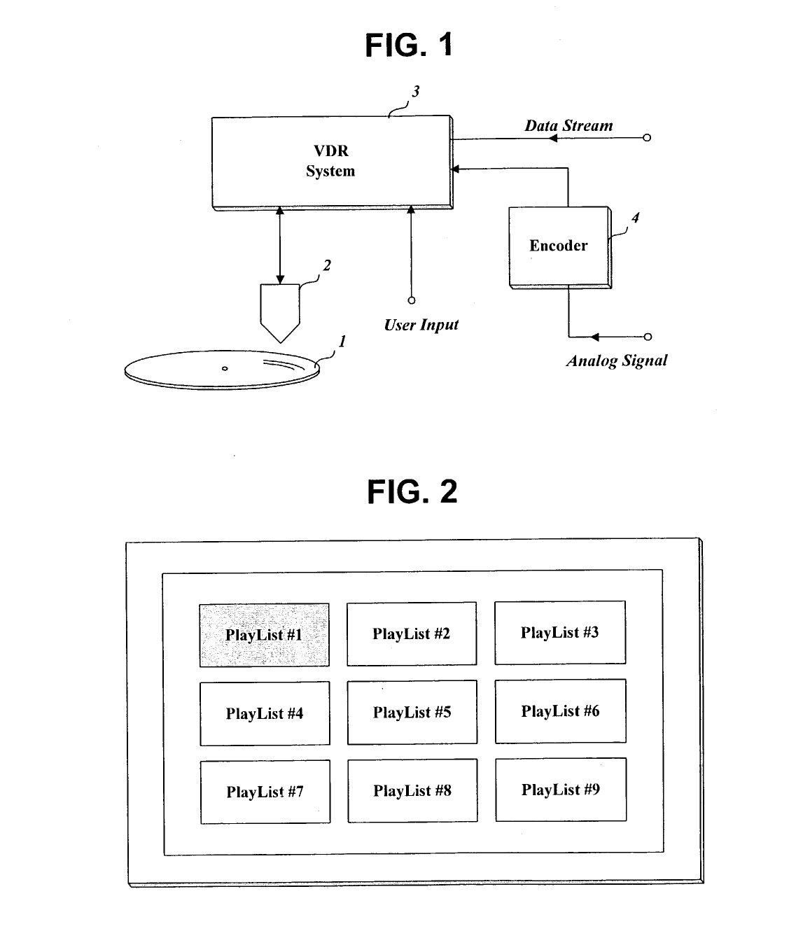

The VDR system 3 of the disk device of FIG. 1 searches the MPD area in the file ‘info.dvr’ for the play list summarized information first. Therefore, summarized information for all play lists can be known faster without searching for play list files (*.rpls, *.vpls) under the subdirectory ‘PLAYLIST’ individually.

The thumbnails representing respective play lists are read at a time from the file ‘menu.tidx’ with reference to the indexes written in the play list summarized information, and then displayed as menu items on a screen of a connected television set, as illustrated in FIG. 2.

The VDR system 3 can refer to the additionally added flags such as the lately-recorded, the lately-edited, and the lately-played flag if a user enters a specific condition, for instance, lately recorded, lately-edited, or lately-played play lists. In this case, only play lists of which flags of summarized information are individually matched with the set condition are displayed on a menu screen for user selections.

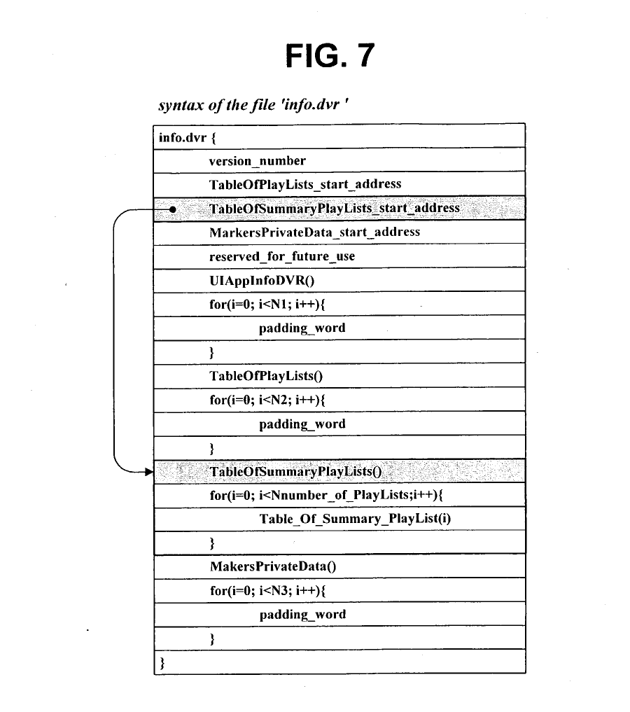

FIG. 7 shows another syntax of the file ‘info.dvr’ in which play list summarized information is written in accordance with the present invention. In the structure of the file ‘info.dvr’, the table ‘TableOfSummaryPlayLists’ where the play list summarized information is written is located not in the MPD but between the play list table ‘TableOfPlayLists’ and the MPD.

In addition, the field ‘TableOfSummaryPlayLists_start_address’ is newly allocated in the file ‘info.dvr’ for storing the start address of the table ‘TableOfsummaryPlayLists’ besides the field ‘TableOfPlayLists_start_address’ for pointing the play list table and the field ‘MakersPrivateData_start_address’ for pointing MPD.

The VDR system 3 can access the play list summarized information table ‘TableOfSummaryPlayLists’ by referring to the start address written in the field ‘TableOfSummaryPlayLists_start_address’. Afterwards, the accessed play list summarized information for all or some play lists are displayed onto a menu screen for user selections.

Same as the previous embodiment, the VDR system 3, in this embodiment, can refer to the additionally added flags such as the lately-recorded, the lately-edited, and the lately-played flag if a user enters a specific condition, e.g., lately recorded, lately-edited, or lately-played play lists, and display onto a menu screen for user selections only play lists of which flags of summarized information are individually matched with the set condition.

The above-explained method for managing play list summarized information can display fast summarized information of play lists such as thumbnails by accessing the concentrated summary information without searching for a plurality of play list files individually. Therefore, it can solve such drawbacks that summary information of all play lists is displayed intermittently and that summary information displaying takes relatively long time.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method of managing information of play lists, including the step of writing summary information in a specific file other than a play list file, said summary information being summarized from information written in play list files created under file structure of a recording medium.

2. The method of claim 1, wherein said specific file is located under an upper directory than a directory under which said play list files are recorded.

3. The method of claim 2, wherein a parent directory of said upper directory is a root directory.

4. The method of claim 1, wherein said summarized information is written in a maker private data area allocated in the specific file.

5. The method of claim 1, wherein said summarized information is written in an area separated from a maker private data area allocated in the specific file.

6. The method of claim 5, wherein the specific file includes address information to point to the separated area.

7. The method of claim 1, wherein said summarized information includes at least one flag among a first flag that is set if recorded last, a second flag that is set if edited last, and a third flag that is set if played last.

8. The method of claim 1, wherein name of the specific file is ‘info.dvr’.

9. A method of managing information of play lists, comprising the steps of:
(a) reading play list summarized information written in a specific file other than a play list file created under file structure of a recording medium; and
(b) displaying at least one thumbnail representing a play list onto a menu screen for user selections with reference to the read play list summarized information.

10. The method of claim 9, wherein the specific file is located under a subdirectory of a root directory.

11. The method of claim 9, wherein said play list summarized information is written in a maker private data area allocated in the specific file.

12. The method of claim 9, wherein said play list summarized information is written in an area separated from a maker private data area allocated in the specific file.

13. The method of claim 12, wherein said step (a) reads an address to point to said separated area first, and accesses said play list summarized information written in said separated area with reference to the read address.

14. The method of claim 9, wherein said step (b) displays onto a menu screen for user selection at least one thumbnail representing a play list that is recorded, edited, or played last with reference to the read play list summarized information.

15. The method of claim 9, wherein name of the specific file is ‘info.dvr’.
